(19) United States
(12) Patent Application Publication
(10) Pub. No.: US 2002/0044368 A1
(43) Pub. Date: Apr. 18, 2002

(54) Method and apparatus for observing magnetic transfer subpulse

(76) Inventor: Tsuyoshi Yoshizawa, Nagano (JP)

Correspondence Address: ROSSI & ASSOCIATES, P.O. Box 826, Ashburn, VA, 20146-0826, US

(21) Appl. No.: 09/950,565

(22) Filed: Sep. 11, 2001

(30) Foreign Application Priority Data
Sep. 11, 2000 (JP) 2000-275258

(51) Int. Cl. G11B 5/86; G11B 27/36; G11B 20/20

(52) U.S. Cl. 360/16; 360/26; 360/31

(57) ABSTRACT

A method and apparatus enables observation of a subpulse signal, which is generated due to improper transfer conditions, while reducing the effect of noises on the subpulse signal. A servo signal, which is recorded on a transfer medium by magnetic transfer, is sampled a plurality of times via a head and a head amplifier, and a data collecting device collects plural pieces of waveform data. After a computer section then compares the waveform data to find a phase difference, the phase is corrected to produce an averaging waveform of each waveform. The produced averaging waveform is displayed on a monitor in order to be used for observation of the subpulse signal.

### FIELD OF THE INVENTION

The present invention relates generally to a method and apparatus for evaluating an information recording medium such as a hard disk, and more particularly to a method and apparatus for observing a recording medium on which a signal is recorded by magnetic transfer.

### BACKGROUND OF THE INVENTION

A magnetic disk drive, which reads or writes information via a floating head while rotating a recording medium disk at a high speed, has been put into practical use for an external storage device of a computer and the like. Tracks are concentrically provided at regular intervals on the surface of a magnetic disk used for the magnetic disk drive. Digital information can be recorded in and regenerated from the tracks.

Ordinarily, necessary information for positioning the head is written on the tracks of the magnetic disk at regular intervals by a so-called preformatting method. Conventionally, the preformatting method has been executed mainly by using a servo track writer.

In recent years, a new magnetic transfer method has been developed. In this method, a direct-current magnetic field is applied while a master disk on which control information is recorded is adhered to a transfer disk, So that the control information is directly transferred onto the disk. It is therefore possible to execute the method within a short period of time, and moreover, it is easy to cope with a narrow track pitch.

The above-mentioned magnetic transfer method depends on the transfer conditions. For example, a subpulse is generated if the transfer conditions are inappropriate. This is a phenomenon wherein a false pulse is generated on a base line of a pulse waveform of a transfer signal as shown in FIG. 6(a). Although adjusting the specific transfer conditions can reduce the generation of the subpulse signal, it is difficult to completely inhibit the subpulse signal due to a tradeoff with respect to other characteristics. It is therefore necessary to observe the subpulse signal in evaluation of the transfer medium and check a signal level of the subpulse signal.

The evaluation of the signal on the transfer medium was executed by using a spin stand for regenerating a servo signal from the transfer medium and a digital oscilloscope for observing the servo signal by using the following procedure.

First, the transfer medium is set on the spin stand and is rotated at a high speed so that the magnetic head can regenerate a transfer signal. The transfer signal is triggered by every index pulse, which is outputted from the spindle motor once per rotation, and is observed through the oscilloscope. At that time, a servo signal waveform as shown in FIG. 7 is observed. In FIG. 7, reference numeral 30 denotes a monitor screen of the digital oscilloscope; 31, a servo burst; and 32, a DC erase section. One hundred to two hundred servo bursts exist on one track of the transfer medium, and each servo burst is comprised of a synchronizing section and an inherent bit pattern such as an address mark. A regenerated signal at the synchronizing section has a single frequency of about 5 MHz.

Next, a specific servo burst is selected and the synchronizing section thereof is enlarged to display pulses of several cycles on the screen of the digital oscilloscope as shown in FIG. 6(a). The transfer signal is evaluated based upon the enlarged waveform displayed on the screen. In evaluation of the subpulse signal, an area close to a base line of the pulse signal of the enlarged waveform displayed on the screen is observed to check the presence of a subpulse and the oscillation level thereof. Conventionally, the observation was carried out at various track positions on the medium by using the above procedure.

Since the subpulse is a faint signal, the noises affect the observation of the subpulse in many cases. Particularly in the peripheral area, the ratio of S/N is lowered to make the observation difficult. For example, in FIG. 6(b), it is difficult to determine whether a subpulse signal exists or not because it is incorporated in the noise. In an example of a method to address this problem, a low pass filter is used to reduce high-frequency noises. In this method, however, the waveform information is lost since the high-frequency components of the signal are also eliminated at the same time. The digital oscilloscope has an averaging function of eliminating the noise from a synchronizing signal. According to this function, the synchronous signal is triggered a plurality of times by the same phase and is averaged to be displayed on the monitor. If this function is used for the observation of a servo signal, an index pulse from the spindle motor is used as a trigger signal. In this case, however, jitter components of the motor rotation cause a phase error in each trigger, and this makes it impossible to acquire a correct averaging waveform.

Further, in the conventional method, a measuring instrument (digital oscilloscope) must be operated every time an observation range in the servo burst is accessed. Consequently, the increase in observation points results in the increase in the number of times the measuring instrument is operated, and this requires a lot of time and effort.

It is therefore an object of the present invention to correctly observe a faint subpulse signal without requiring a lot of time and effort.

### SUMMARY OF THE INVENTION

To solve the above-mentioned problem, the invention provides a method for observing a magnetic transfer subpulse signal, comprising the steps of: acquiring plural pieces of waveform data by sampling a servo signal a plurality of times, the servo signal being regenerated from a transfer medium on which the servo signal is recorded by magnetic transfer; comparing respective waveform data to find a phase difference thereof and correct a phase; producing an averaging waveform by using respective waveform data; and displaying, on a screen, the produced averaging waveform for use in observing the magnetic transfer subpulse signal.

The invention further provides an apparatus for observing a subpulse signal generated due to poor transfer of a transfer medium on which a servo signal is recorded by magnetic transfer, the apparatus comprising: means for converting a servo pattern recorded on the transfer medium into an electric signal to produce a regenerated servo signal; means for sampling one cycle of the regenerated servo signal by using a pulse signal as a trigger, the pulse signal being synchronous with rotation of the transfer medium; means for recognizing a position of a specific servo burst from sampling data of one cycle of the regenerated servo signal; means for acquiring plural pieces of waveform data in an observation range designated in the specific servo burst by performing the sampling operation a plurality of times; means for comparing the plural pieces of waveform data to produce an estimated phase difference; means for correcting a phase according to the estimated phase difference to thereby produce an averaging waveform; and means for displaying the averaging waveform for use in observing the subpulse signal.

In addition, the means for comparing estimates the phase difference by executing a cross-correlation operation of the waveform data in the observation range.

### BRIEF DESCRIPTION OF THE DRAWINGS

The invention will now be described with reference to certain preferred embodiments thereof and the accompanying drawings, wherein:

FIG. 1 is a block diagram showing an embodiment of the present invention;

FIG. 2 is an explanation drawing showing a program window;

FIG. 3 is a flow chart useful in explaining an observation method according to the present invention;

FIGS. 4a, 4b, and 4c are drawings showing the range where waveforms are overlapping;

FIG. 5 is an explanation drawing showing a cross-correlation function;

FIGS. 6a, 6b, and 6c are drawings showing a subpulse signal of a digital oscilloscope; and

FIG. 7 is an explanation drawing showing a monitor screen of a digital oscilloscope.

### DETAILED DESCRIPTION OF THE PREFERRED EMBODIMENTS

FIG. 1 is a block diagram showing an embodiment of the present invention.

Reference numeral 14 denotes a transfer medium as a subject of evaluation, and reference numeral 8 denotes a spin stand for regenerating a transfer signal from a transfer medium 14. The spin stand 8 is comprised of a spindle motor 13 for rotating the transfer medium 14, a head 10 for regenerating a magnetic signal, a positioner 12 for positioning the head 10, a head amplifier 11 for amplifying a regenerated signal. A mark d1 indicates a read signal that is amplified by the head amplifier 11.

The output of the head amplifier 11 connects to a data collecting device 6. The data collecting device 6 is comprised of an A/D converter 15 and a buffer memory 16. For example, the A/D converter 15 is configured to have eight quantized bits, an input range of ±300 mV, and a full scale from −128 to +127 for conversion data. The sampling frequency of the A/D converter 15 is set to, e.g. 250 Msps (Msps: Mega Samples per Second).

The buffer memory 16 is a memory that temporarily contains data sampled by the A/D converter 15 and has a sufficient capacity to contain sampling data of one track on the transfer medium 14.

Reference numeral c2 denotes an index pulse, which is generated by the spindle motor 13 at a certain rotational angle once per rotation. The index pulse c2 determines a timing in which the data collecting device 6 starts sampling data.

A computer section 1 is, for example, a personal computer. The computer section 1 is comprised mainly of a CPU (processing device) 2, an external storage device 3, a memory 4 and a monitor 17. Reference numeral 5 denotes a program of the computer section 1. The computer section 1 and the data collecting device 6 are connected to each another via a communication line c1, so that commands and data are transmitted between them.

A description will now be given of a process for observing a subpulse signal.

First, the medium 14 to be observed is set on a rotary shaft of the spindle motor 13. The spin stand 8 is then operated and activated. This causes the transfer medium 14, which is set on the rotary shaft of the spindle motor 13, to start rotating and reach a steady revolving speed (e.g. 5,400 rpm). Further, the head 10 moves in association with the positioner 12 to a predetermined load position of the transfer medium 14 and is loaded.

Next, the head 10 seeks (moves to) a track of the transfer medium 14 of the transfer medium 14 to be measured. This causes the head 10 to regenerate a transfer signal of the track, and the signal is amplified by the head amplifier 11 and is outputted as a read signal d1. The amplification of the outputted read signal d1 is about ±270 mV that is equivalent to about 90% of the input range of the A/D converter 15. The amplification of the read signal d1 can be changed by adjusting the gain of the head amplifier 11.

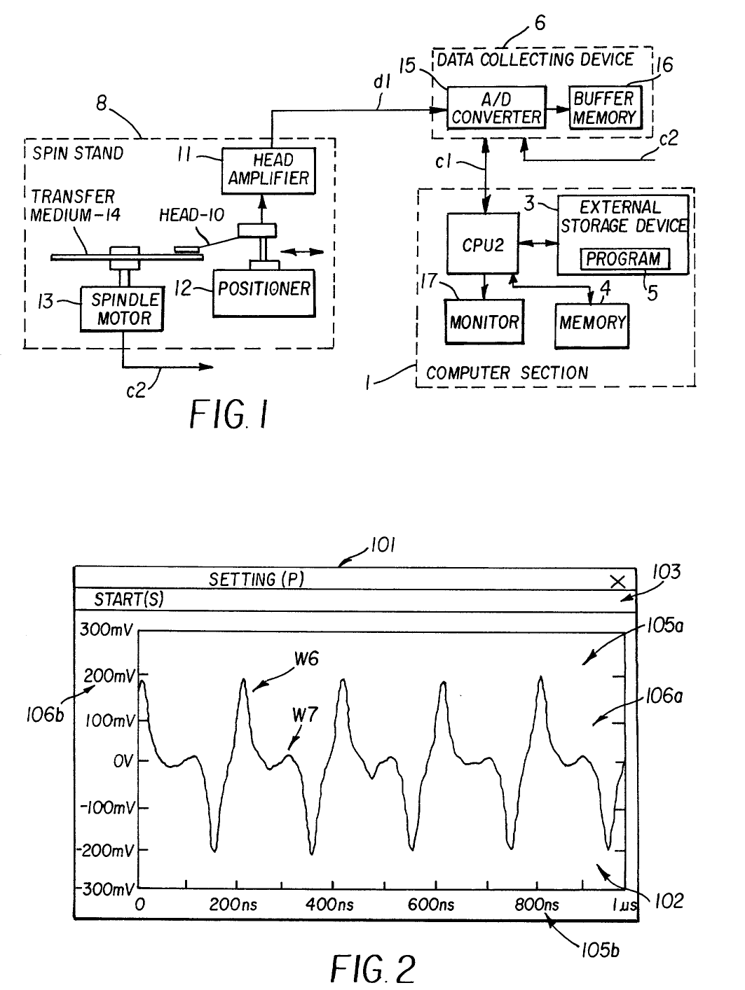

A keyboard, not shown, of the computer section 1 is then operated to activate the program 5. When the program 5 is activated, a program window 101 is displayed on a monitor 17 of the computer section 1 as shown in FIG. 2. A waveform display window 102 for showing an averaging waveform and a menu 103 for a user to set and control the program 5 are arranged in the program window 101.

The observation conditions are then set in the program 5. Examples of the observation conditions are a servo burst number, an observation time width, and an average number of times.

The servo burst number is used to designate a servo burst in which the observation range is set. More specifically, Number 1 is assigned to the first servo burst after the setup edge of the index pulse c2, and No. 2 is assigned to the next servo burst. The observation time width represents the observation time width of a waveform at a synchronizing section in the designated servo burst. In the following description, the observation time width is set to 1 μs. The average number of times represents the number of times the data is acquired for the averaging process. In the following description, the average number of times is set to 5.

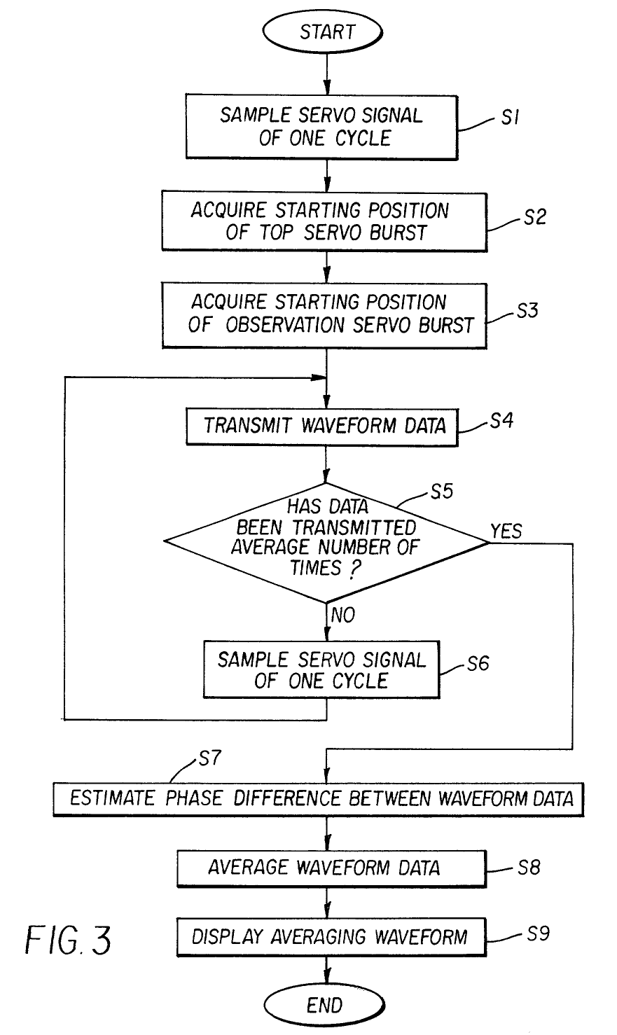

The program 5 is then operated to start acquiring a waveform. FIG. 3 is a flow chart useful in explaining a method for acquiring a waveform.

First, a servo signal in one cycle is sampled in a step s1. The CPU 2 sends a control command via the communication line c1 so as to instruct the data collecting device 6 to start collecting data. The CPU 2 then waits for a period of time enough for the data collecting device 6 to complete sampling the data (a period of time equivalent to two rotations of the spindle motor 13). In accordance with the command from the CPU 2, the data collecting device 6 starts monitoring the index pulse c2.

If the spindle motor 13 has reached a certain rotational angle and the index pulse c2 has changed from Low to High, the data collecting device 6 sequentially stores the data sampled by the A/D converter 15 in a buffer memory 16 from a top address. If the number of stored data has reached a preset number of data N1, the data collecting device 6 stops storing the data. In this case, the number of data N1 is determined according to the following equation:

N1=N_{WW}×(N_{B}+1) (1)

where the number of servo bursts per track on the transfer medium 14 is regarded as N_{B} and the number of data between the servo bursts is regarded as N_{WW}.

In a next step s2, a starting position (address in the buffer memory 16) of the top (first) servo burst is searched for from the sampling data by using the following procedure:

1) first, the sampled data is sequentially checked from a top address, and the sequential number of data wherein the absolute value of a data value thereof is not greater than V₁ is counted;

2) next, an address where the number of data reaches N₂ is found; and

3) the search is started from this address so as to find an address where the absolute value of a data value exceeds V₁.

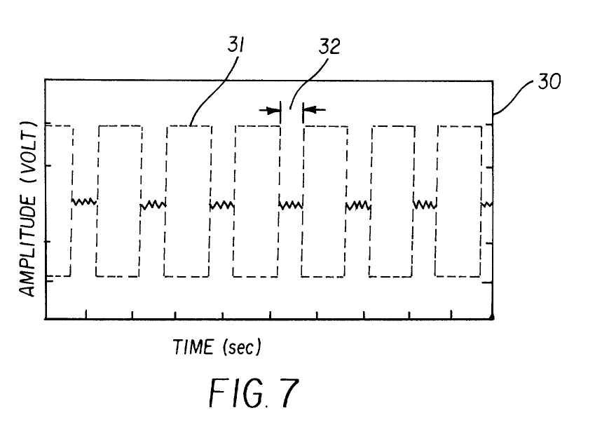

N₂ is a threshold level for determining a DC erase section denoted by reference numeral 32 in FIG. 7. If the number of data in the DC erase section found from a sampling rate is defined as N_{DC}, the following equation can be formed:

N₂=N_{DC}×0.8 (2)

V₁ is a threshold level in distinguishing a noise from a pulse signal, and for example, V₁ is set to, e.g. “40” that is equivalent to about 15% of the full scale of the A/D converter 15. Thus, the starting address (P₁) of the first servo burst is found.

In a next step s3, a starting address of a servo burst to be observed is searched for. Accordingly, a search starting address is determined first by the following equation:

search starting address=P₁+(B_{N}−1)×N_{WW}−N_{DC}/2 (3)

where P₁ represents a starting address of the first servo burst, B_{N} represents a number of a servo burst to be observed, N_{WW} represents the number of data between servo bursts, and N_{DC} represents the number of data in the DC erase section.

The sampling data in the buffer memory 16 is then checked from the search starting address so as to find an address where the absolute value of the sampling data exceeds V₁ for the first time. Consequently, a starting address P₂ of a servo burst to be observed is found.

In a step s4, the waveform data at the periphery of the observation range is transmitted. Accordingly, a transmission starting address and the number of transmission data are determined first. The synchronizing section, in which the observation range is set, starts at the top of the servo burst. Thus, the transmission starting address is the starting address P₂ of the servo burst to be observed, which is found in the step s3. The number of transmission data is determined by the following equation:

Ns=N_{W}+N_{P}+1 (4)

where NW and NP represent the observation time width and the number of sampled data equivalent to one cycle of a pulse of the servo signal, respectively. For example, the number of data is 301 if the observation time width is 1 μs and the sampling frequency is 250 Msps.

The CPU 2 reads Ns sampling data from the transmission starting i address in the buffer memory 16, and stores this in the memory 4 as waveform data obtained by the first sampling operation.

In a step s5, it is determined whether waveform data has been transmitted the average number of times or not. In this embodiment, the average number of times is set to five, and thus, the process proceeds to a step s6. In the step s6, the servo signal of one cycle is sampled in the same manner as in the step s1. As a result, new sampling data in the same track is stored in the buffer memory 16 of the data collecting device 6. The process then proceeds to a step s4. In the step s4, new waveform data sampled for the observation range is transmitted, and is stored in the memory 4 as waveform data obtained by the second sampling operation.

Thereafter, the same process is repeated to acquire five pieces of waveform data for the same observation range by carrying out five sampling operations. The acquired waveform data is transmitted to the computer section 1, and is stored in the memory 4. The process then proceeds to a step s7.

In the step s7, the waveform data in the memory 4, which has been acquired by the first to five sampling operations, are compared to one another to estimate a phase difference between waveforms by using the following procedure. First, the first data is compared with the second data. Accordingly, a cross-correlation operation such as the equation (5) in a mathematical expression 1 is executed. In the equation (5), x₁(n) and x₂(n) represent the first and second waveform data, Ns represents the number of sampling data, C(k) represents a cross-correlation function, and k represents a lag time of a cross-correlation function and a unit thereof is a sample. Mathematical Expression 1 is expressed as follows:

$$C ( k ) = \frac{1}{Ns} \cdot {\sum }_{n = L 1}^{Ns - L 1 - 1} x1 ( n ) \cdot x2 ( n + k ) - {L}_{1} \leq k \leq {L}_{1} \qquad ( 5 )$$

Further, L₁ is defined by the following equation:

L₁=Cei1[Np/2] (6)

where Np represents the number of sampling data equivalent to one cycle of pulse in the synchronizing section. For example, Np is 50 if the pulse frequency is 5 MHz and the sampling rate is 250 Msps.

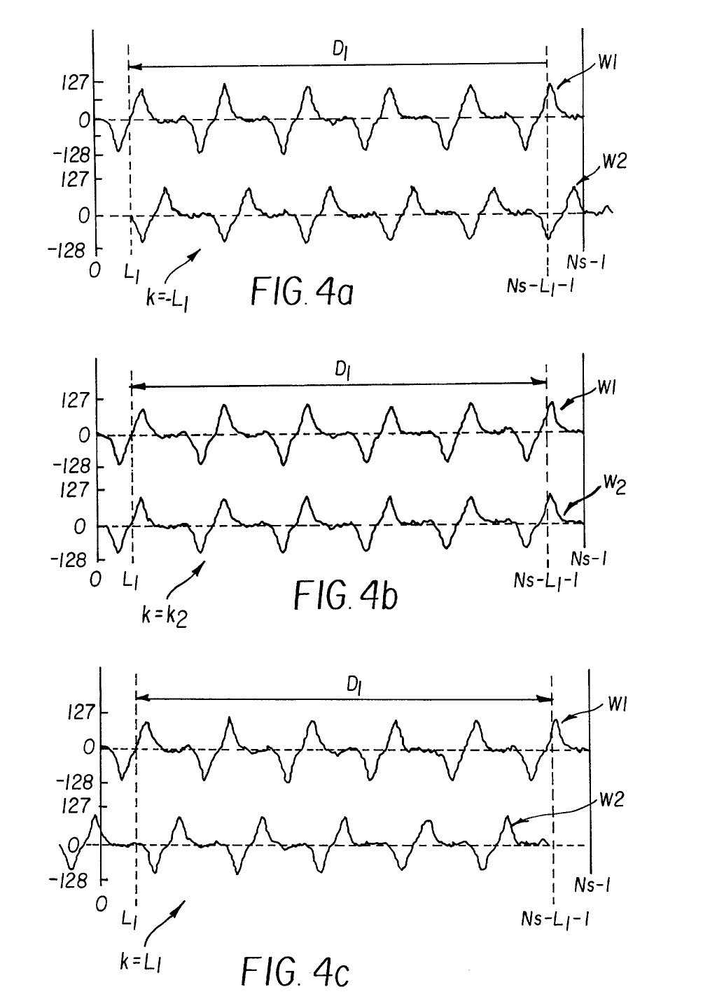

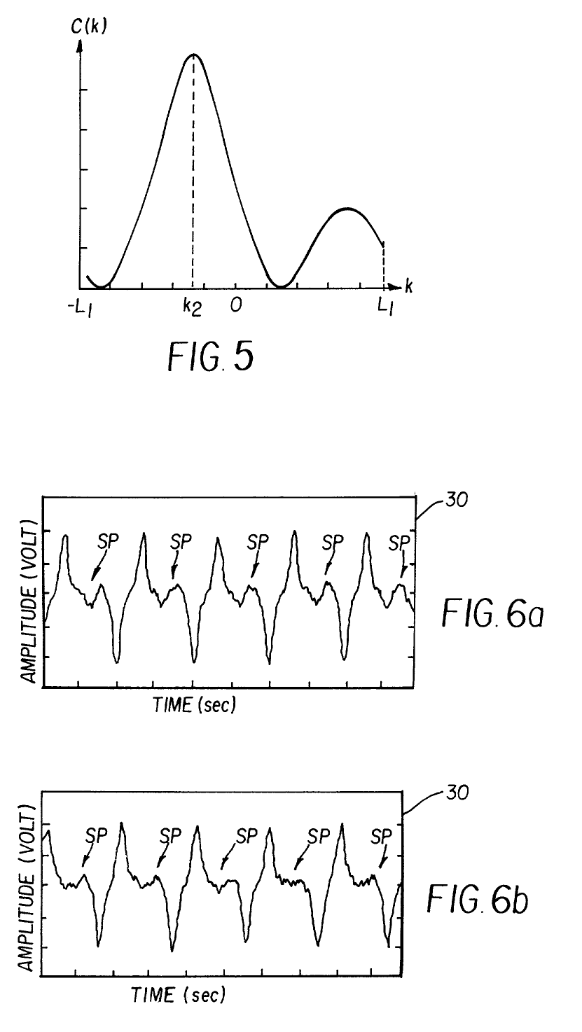

The above equation (6) is equivalent to horizontally offsetting the second waveform from the first waveform by half cycle of pulse at the maximum to find the correlation of a range where waveforms are constantly overlapping. FIGS. 4(a), 4(b) and 4(c) are explanation drawings thereof under the respective ones of the following conditions: k=−L₁, k=k₂, and k=L₁. In FIG. 4, W1 and W2 represent the first waveform and the second waveform, respectively, and D₁ represents a range where a correlation is found. Under the condition of k=k₂, the phases of the waveforms W1 and W2 substantially conform to each other as shown in FIG. 4(b). The cross-correlation function C(k) has such characteristics as shown in FIG. 5 wherein a peak value comes under the condition of k=k₂.

For this reason, the value k₂ of k which provides a peak value of the cross-correlation function C(k) is found under the condition of −L1≦k2≦L1, and the found value k₂ is converted into the number of samples to be used as an estimate of a phase difference between waveforms. The phase difference per sample is supposed to be smaller than a half cycle of the pulse signal. Similarly, cross-correlation functions are found for the first and third waveform data, the first and fourth waveform data, and the first and fifth waveform data to find estimates k3, k4, k5 of the respective phase differences.

In a step s8, an averaging process is executed for the first to fifth waveform data. The averaging process is executed for the second to fifth waveform sampling data and the first waveform data by correcting the phase difference from the first waveform data, which is found in the step s7. That is, the calculation is carried out according to the equation (7) in a mathematical expression 2 shown below. In this equation, x₁(n) represents the first waveform sampling data, xₘ(n) (m−2, 3, . . . 5) represents the second to fifth waveform sampling data, kₘ (m=2, 3, . . . 5) represents the estimate of the phase difference found in the step s7, N_{avg} represents the average number of times (five times in this example), and x_{avg} represents the averaging waveform data. The number of sampling data x_{avg} (n) (L₁≦n≦−Ns−L₁−1) acquired by the equation (7) is found by the following equation: Ns−2×L₁, and is equal to or larger than the number of data Nw equivalent to the observation time width by one. Mathematical Expression 2 is expressed as follows:

$${x}_{avg} ( n ) = ( {x}_{1} ( n ) + {\sum }_{m = 2}^{{N}_{avg}} {x}_{m} ( n + {k}_{m} ) ) / {N}_{avg} {L}_{1} \leq n \leq Ns - {L}_{1} - 1 \qquad ( 7 )$$

In a step s9, the produced averaging waveform is displayed in the waveform display window 102 in FIG. 2.

The time axis (horizontal axis) of the waveform display window 102 is set within the observation time width (1 μs in this example) from 0 second, and the voltage axis (vertical axis) is set within the full scale (between −300 mV and 300 mV) of the A/D converter 15.

The CPU 2 maps in the waveform display window 102 Nw data equivalent to the observation time width from n=L₁ among the averaging waveform data x_{avg} (n) (L₁≦n≦Ns−L₁−1). That is, the CPU 2 make the condition of n=0−Nw−1 correspond to 0 sec-1 μsec, and make the data value of −128-+128 correspond to the full scale of −300 mV-300 mV. Further, the CPU 2 describes a straight line connecting the mapped data points together in the waveform display window 102.

Further, the CPU 2 calculates and describes the appropriate positions and values of a time axis scale 105a, a time axis label 105b, a voltage axis scale 106a, a voltage axis label 106b, and so forth in the program window 101.

Consequently, an averaging waveform W6 is displayed in the waveform display window 102 in FIG. 2. W7 indicates a subpulse signal waveform included in the averaging waveform W6. The shape of the waveform W7 can clearly be recognized because the averaging process eliminates base line noises. To observe a signal of another servo burst signal in the same track, the program 5 is operated to designate a servo burst number and then start acquiring a waveform again.

The present invention achieves the following four results.

First a waveform for observation of the subpulse signal is displayed as the averaging waveform produced from a plurality of waveform data in the observation range, and this enables the observation of a faint subpulse signal that cannot be easily observed due to the noises in the prior art.

Second, even if there is a phase difference between the respective waveform data in the observation range, a correct averaging waveform can be acquired since the phase difference is estimated and corrected before the averaging process.

Third, when there is a phase difference between the waveform data in the observation range, a peak value of the cross-correlation function between the waveform data varies according to the phase difference. Accordingly, the cross-correlation function is found by executing the cross-correlation operation of the waveform data and detecting a difference between peak positions thereof.

Fourth, before the acquisition of the waveform data in the observation range, the sampling data on the servo signal of one cycle is checked to automatically recognize the position of a specific servo burst where the observation range is set. This significantly reduces the time and effort for accessing the observation range.

What is claimed is:

1. A method for observing a magnetic transfer subpulse signal, comprising the steps of:
acquiring plural pieces of waveform data by sampling a servo signal a plurality of times, said servo signal being regenerated from a transfer medium on which the servo signal is recorded by magnetic transfer;
comparing respective waveform data to find a phase difference thereof and correct a phase;
producing an averaging waveform by using respective waveform data; and
displaying, on a screen, the averaging waveform for use in observing the magnetic transfer subpulse signal.

2. An apparatus for observing a subpulse signal generated due to poor transfer of a transfer medium on which a servo signal is recorded by magnetic transfer, said apparatus comprising:
means for converting a servo pattern recorded on the transfer medium into an electric signal to produce a regenerated servo signal;
means for sampling one cycle of the regenerated servo signal by using a pulse signal as a trigger, the pulse signal being synchronous with rotation of the transfer medium;
means for recognizing a position of a specific servo burst from sampling data of one cycle of the regenerated servo signal;
means for acquiring plural pieces of waveform data in an observation range designated in the specific servo burst by performing said sampling operation a plurality of times;
means for comparing the plural pieces of waveform data to produce an estimated phase difference;
means for correcting a phase according to the estimated phase difference to thereby produce an averaging waveform; and
means for displaying the averaging waveform for use in observing the subpulse signal.

3. An apparatus for observing a magnetic transfer subpulse according to claim 2,
wherein said means for comparing estimates the phase difference by executing a cross-correlation operation of the waveform data in the observation range.
